(19) United States
(12) Patent Application Publication
(10) Pub. No.: US 2009/0311653 A1
(43) Pub. Date: Dec. 17, 2009

(54) Test Preparation Method

(76) Inventor: Stanley A. Kim, Wellington, FL (US)

Correspondence Address: Stanley A. Kim, 12697 Headwater Circle, Wellington, FL, 33414, US

(21) Appl. No.: 12/137,349

(22) Filed: Jun. 11, 2008

(51) Int. Cl. G09B 19/22

(52) U.S. Cl. 434/128

(57) ABSTRACT

A method for preparing for a test includes providing a test preparation device compatible with game boards having thereon several different game piece spaces among which student/test taker can move game tokens. Play is accomplished by one student/test taker rolling a die or dice and then moving his token the number of spaces indicated by the die or dice. The student/test taker is then asked a question from a problem card of the test area subject subset correlated with the landed on game token space (e.g., as indicated by the discernible identifier associated with the particular game space). If the student/test taker answers the question correctly, he is awarded a point or like reward, and then repeats his turn until he fails to answer a question correctly. Thereafter, the next student/test taker has his turn. The game continues until one student/test taker wins. Winning can be accomplished in a number of ways, e.g., by being the first student/test taker to answer a question from each test area subject subset correctly, by accumulating a target number of points, or by having the largest number of points after a designated time period (e.g., 30, 45, 60, 90, 120, or 180 minutes).

### CROSS-REFERENCE TO RELATED APPLICATIONS

The present application claims the priority of U.S. patent application Ser. No. 11/059,597 filed Feb. 16, 2005 and U.S. provisional patent application Ser. No. 60/642,261 filed Jan. 7, 2005.

### FIELD OF THE INVENTION

The invention relates to test preparation devices and methods of use. More specifically, the invention relates to methods for preparing for a test using a test preparation device including a set of problem cards adapted for use in a board game.

### BACKGROUND

Educational devices that aid in learning and facilitate memorizing facts or concepts are useful for students preparing for examinations. For example, students have long used flash cards to prepare for examinations. A typical flash card has a question printed on the front face and the corresponding answer on the back face. Rather than containing a variety of questions from disparate subjects, flash cards designed for preparing students for specific examinations are typically marketed as a set of cards having different questions on a single subject or area of study, e.g., history, math, English, foreign languages, sociology, psychology, biology, chemistry, physics, law, medicine, nursing, business management, accounting, engineering, criminology, fire fighting, and others. Sets of flash cards may include questions from subsets of a subject, e.g., geometry (math), organic chemistry (chemistry), genetics (biology), torts (law), etc. While the use of flash cards is helpful for many students, their prolonged use can be tedious. Thus, students often discontinue their use after only a short period of time.

### SUMMARY

The invention is based on the development of the idea that problem cards compatible with board games can be used to facilitate learning of academic subjects and preparing for examinations. In addition to containing a question in an academic subject or test area, each problem card of the invention can be marked with at least one discernible identifier that corresponds to one or more discrete game token spaces on a game board. The inclusion of discernible identifiers on problem cards thus allows students/test takers to combine playing a game with studying or preparing for a test.

A major advantage of the invention over conventional flash cards is that it allows multiple students/test takers to study together in a competitive and fun environment. The invention thus permits student/test takers to avoid the boredom, tedium, and loss of attention which often accompanies conventional methods of studying or preparing for exams. The invention is also economical and easy to use in that the problem cards can be designed for use with game boards that a student/test taker might already own and have previously played for recreational purposes.

Accordingly, in one aspect, the invention features a test preparation device compatible for use with a game board having at least a first game token space and a second game token space. The device includes a plurality of problem cards each having thereon at least one question in a test area. The plurality of problem cards includes at least (a) a first card including a first discernible identifier (e.g., a shape, color, symbol/icon, or alphanumeric character or string of characters) corresponding to the first game token space and a first test preparation question relating to a first subset of the test area and (b) a second card including a second discernible identifier corresponding to the second game token space and a second test preparation question relating to a second subset of the test area. The first discernible identifier differs from the second discernible marking, the first test preparation question differs from the second test preparation question, and the first subset differs from the second subset.

The test area can be subject matter from a standardized test such as a school admission test (e.g., the SAT, ACT, GRE, GMAT, LSAT, or MCAT), a licensure test (e.g., a bar examination, the USMLE, or the NCLEX). Questions on the problem cards can be in various formats including multiple choice, true/false, and fill in the blank.

In another aspect, the invention features a method for preparing at least a first person and at least a second person for a standardized test. This method includes the steps of: providing a test preparation device compatible for use with a game board including at least a first game token space and a second game token space, the device including a plurality of problem cards each having thereon at least one question in a test area consisting of subject matter from a standardized test, the plurality of problem cards including at least (a) a first card including (i) a first discernible identifier corresponding to the first game token space and a first subset of the test area, (ii) a first test preparation question relating to the first subset of the test area, (iii) a correct answer to the first test preparation question; and (b) a second card including (i) a second discernible identifier corresponding to the second game token space and a second subset of the test area and (ii) a second test preparation question relating to the second subset of the test area, and (iii) a correct answer to the second test preparation question; wherein the first discernible identifier differs from the second discernible identifier, the first test preparation question differs from the second test preparation question, and the first subset differs from the second subset; providing the game board; having the first person read the first test preparation question on the first card to the second person; allowing the second person to provide an answer to the first test preparation question; having the first person determine whether the second person's answer is the same as the correct answer to the first test preparation question; having the second person read the second test preparation question on the second card to the first person; allowing the first person to provide an answer the second test preparation question; and having the second person determine whether the first person's answer is the same as the correct answer to the second test preparation question.

In the method, the first card might include a question difficulty identifier and/or an explanation/approach for addressing the first test preparation question. The first person can read the question difficulty identifier and/or the explanation/approach (e.g, an explanation of how the first test preparation question is typically solved and/or a suggested shortcut approach for correctly answering the first test preparation question) for addressing the first test preparation question to the second person.

In some embodiments, the method might further include the step of limiting the amount of time the second person has to answer the first test preparation question to simulate the time pressure associated with the standardized test (e.g., to 1, 2, 3, 4, or 5 minute periods).

The method of the invention might be performed using a game board originally intended for recreation rather than preparing for a standardized test. For a game board lacking discernible identifiers associated with game token spaces, and the method might further include associating (permanently or reversibly; e.g., using an adhesive) the discernible identifiers with the game token spaces.

In one arrangement of the method, the first person can arrange the plurality of problem cards into different slots of a problem card holder according to each card's test area subset. The problem card holder might include at least a first slot marked with the first discernible identifier and a second slot marked with the second discernible identifier.

Unless otherwise defined, all terms used herein have the same meaning as commonly understood by one of ordinary skill in the art to which this invention belongs. Although methods and materials similar or equivalent to those described herein can be used in the practice of the present invention, suitable methods and materials are described below. All publications, patent applications, patents, and other references mentioned herein are incorporated by reference in their entirety. In the case of conflict, the present specification, including definitions will control. Other features and advantages of the invention will be apparent from the following detailed description, and from the claims.

### BRIEF DESCRIPTION OF THE DRAWINGS

FIG. 1 is a perspective view of one embodiment of the test preparation device of the invention.

FIG. 2A is a plan view of the front face of a problem card of the invention.

FIG. 2B is a plan view of the back face of a problem card of FIG. 2A.

FIG. 3 is a perspective view of a card holder component of the device of the invention shown with slots loaded with problem cards.

FIG. 4 is a top plan view of a game board component of the device of the invention.

### DETAILED DESCRIPTION

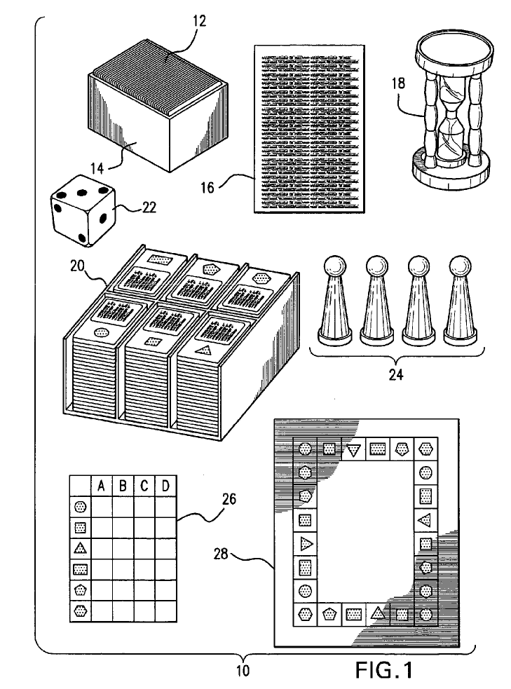

Referring to FIG. 1, a representative test preparation device 10 of the invention features a set of problem cards 12 compatible for use in a multi-player game such as a board game, packaging 14, printed information 16 relating to the device (e.g., instructions for playing a game), a timer 18 for limiting the time a player has to answer a question, a problem card holder 20, a die 22 or like apparatus, game tokens 24, a means to keep track of a score 26, and a game board 28.

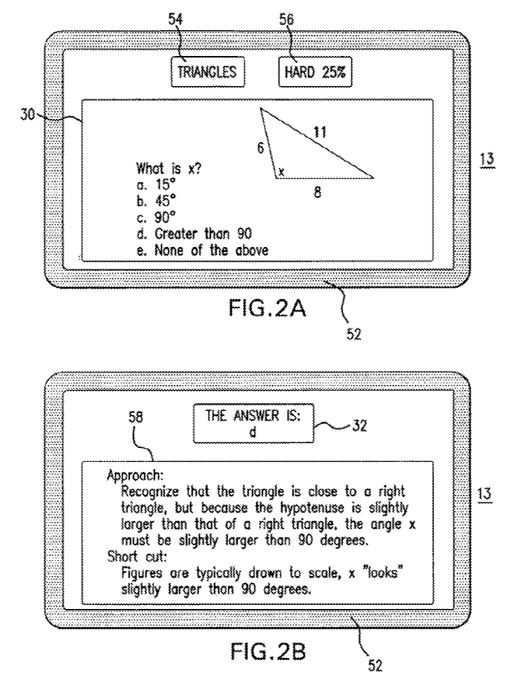

Referring to FIGS. 2A and 2B, the problem cards 13 making up the set 12 each have thereon at least one question 30 (and typically at least one answer 32 to the at least one question 30) in a test area. The number of problem cards contained in the set 12 can vary, but preferably is sufficient to allow a card-based game to be played for at least thirty minutes or an hour. For example, although a set 12 may contain as few as 2, 3, 4, 5, 6, 7, 8, or 9 problem cards; in preferred embodiments, the set 12 contains at least 10 (e.g., at least 15, 20, 25, 30, 35, 40, 50, 60, 70, 80, 90, 100, 150, 200 or more) problem cards.

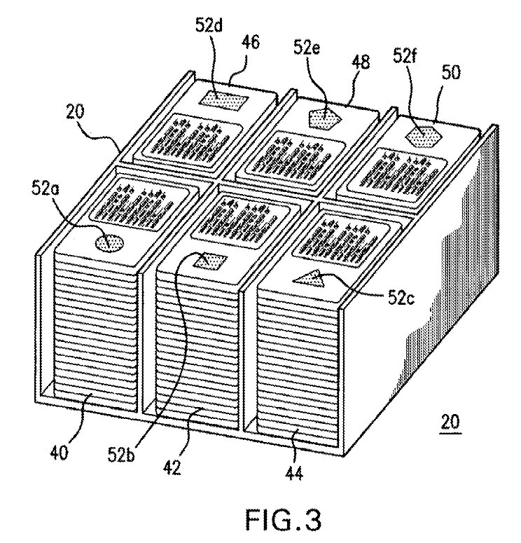

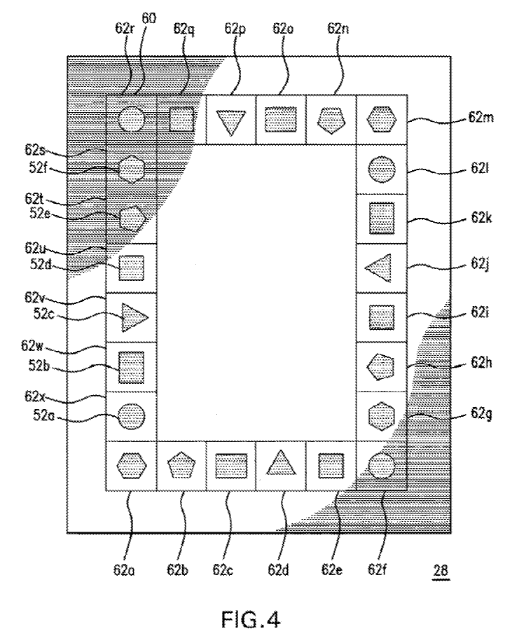

Problem cards of the set 12 can feature questions in two or more subsets of a given test area. For example, referring to FIG. 3, a problem card holder 20 is used to subdivide a set 12 of problem cards 13 for preparing for a math test. The cards 13 are grouped into six subject matter subsets: cards having only arithmetic questions 40, cards having only algebra questions 42, cards having only geometry questions 44, cards having only graph-related questions 46, cards having only trigonometry questions 48, and cards having math questions in areas other than the foregoing (a miscellaneous subset) 50. The different subsets of cards are marked with different discernible identifiers 52a, 52b, 52c, 52d, 52e, and 52f. In the exemplary embodiment shown in FIG. 2, discernible identifiers 52a, 52b, 52c, 52d, 52e, and 52f are different shapes (i.e., a circle, a square, a triangle, a rectangle, a pentagon, and a hexagon). In addition to shapes, the discernible identifiers 52 might take other forms, e.g., different colors, (e.g., red, blue, yellow, orange, green, purple, and pink), symbols, writings (colors, shapes, or test area subsets spelled out as a word), or a combination of the foregoing (e.g., a red circle, a blue square, etc.). To make problem cards compatible with a particular board game, the discernible identifiers 52 can be selected to match those used to differentiate game token spaces on the game board associated with the board game. For example, the problem cards 13 of FIG. 3 would be compatible with a game board having game token spaces marked with either a circle, a square, a triangle, a rectangle, a pentagon, or a hexagon (see, e.g., FIG. 4).

A representative problem card 13 of the invention for preparing for a math test is shown in FIGS. 2A and 2B. The front face of problem card 13 shown in FIG. 2A has printed thereon a question 30, a discernible identifier 52 (in this case a border of a certain color), a category indicator 54, and a question difficulty indicator 56. The back face of problem card 13 shown in FIG. 2B has printed thereon an answer 32 to the question 30, a discernible identifier 52, and an explanation/approach 58 for addressing the question 30.

In this embodiment, the question 30 is a multiple-choice geometry question in the field of triangles. To indicate that the question 30 is in the geometry subset of math questions, the discernible identifier 52 is a colored (e.g., yellow) border around the edges of the card 13. To provide further descriptive information about the question 30, the front face of card 13 is also marked with a category indicator 54 and a question difficulty identifier 56. The category indicator 54 in this embodiment is the printed word “TRIANGLES” to indicate that the question 30 relates to triangles, a sub-category of geometry. The question difficulty identifier 56 in this embodiment is the printed phrase “HARD 25%” to indicate that the question 30 is categorized as relatively difficult (compared to questions indicated to be easy, medium, or very hard) and that only 25% of people (e.g., prospective test takers) are expected to answer the question 30 correctly. Other identifiers such as symbols or colors could also be used to designate the category or relative difficulty of the question 30. For example, the relative difficulty of the question 30 could be indicated by color (e.g., green=easy, yellow=medium, red=difficult, and black=very difficult) or, as in the embodiment of FIG. 2A, a number corresponding to the percent of people expected to answer the question 30 correctly (e.g., 1 or less, 2, 5, 10, 25, 50, 75, 90, 95, and 99 or more percent) based on results of prior testing with similar questions.

The back face of the card 13 shown in FIG. 2B has printed thereon the answer 32 (i.e., “The answer is d”) and an explanation/approach 58 for addressing the question 30. The latter is an explanation of how the question 30 is typically solved and a suggested “shortcut” approach. Although the card 13 shown in FIGS. 2A and 2B contains only a single question and answer, in other embodiments the card 13 might contain multiple (e.g., 2, 3, 4, 5, 6, 7, 8 or more) questions and answers in one or more subsets of a test area. In the case where individual cards contain multiple questions in more than one subset of a test area, the different questions on the card can be identified using different discernible identifiers on the same card. For a test area compatible with short questions/answers (e.g., less than about 3 or 2 lines or less than about 15 words), a card might feature several questions/answers. For test areas that typically have longer questions or answers, a card would have fewer questions/answers. For preparing for a standardized examination that generally features long questions (e.g., more than 3, 4, 5, 6, 7, 8, 9, or 10 lines; or more than 15, 20, or 25 words), cards having only a single question/answer are preferred for size limitation reasons. To more closely simulate test conditions, cards having only a single question/answer are also preferred for preparing for standardized examinations in which a test taker usually focuses on a single question at a time. Questions on the problem cards may also be posed in a number of different formats, e.g., multiple choice, true-false, and fill-in-the blank type questions.

The questions on the problem cards can be from any area that is the subject of a test. For example, questions on the problem cards can be directed to an academic subject taught in a school, college, university or technical institute. Examples of academic subjects include one of the liberal arts (e.g., history, math, English, non-English languages, sociology, psychology, biology, chemistry, physics, etc.), a professional field (e.g., law, medicine, nursing, business management, accounting, and engineering), and other subjects taught in an academic setting (e.g., criminology, fire fighting, etc.).

Because the subject matter featured in standardized tests is relatively uniform, the problem cards of the invention are particularly well suited for preparing for such tests. A myriad 30 of standardized tests compatible with the cards of the invention are currently in use. A limited list of examples include college admission tests such as the SAT, ACT, and SAT subject tests; the PSAT/NMSQT; tests for securing advanced placement in college, e.g., AP or CLEP exams; graduate/professional school admission tests such as the GRE general test or a GRE subject test, MCAT, LSAT, DAT, PCAT, OAT, VCAT, AHPAT, GMAT, and MAT; professional licensure or certification exams, e.g., state bar exams (MBE and state-specific portions), MPRE, patent bar examination, medical/veterinary/dental/optometric/chiropractic/osteopathic/pharmacy board exams, CPA exam, series 6 and 7 exams, CFA, FE, PE, LS, ARE, NCIDQ, teacher certification exams (e.g., NYSTCE, FTCE, MTTC and the like), police and fire fighter exams, and civil service exams; language proficiency tests, e.g., TOEFL and TSWE; high school equivalency exams such as the GED; and grade school exams such as the FCAT. Various test preparation companies have compiled lists of questions/answers for preparing for standardized tests. These questions or modifications/adaptations thereof can be used on the problem cards of the invention.

Referring again to FIG. 1, the test preparation device 10 of the invention can feature components to facilitate the use of the set of problem cards 12 with a board game. These include packaging 14, printed information 16 relating to the device, a timer 18 for limiting the time a player has to answer a question, a problem card holder 20, a die 22 or like apparatus, game tokens 24, a means to keep track of a score 26, and a game board 28. The test preparation device 10 can be packaged in several different ways. For example, as shown in FIG. 1, packaging 14 can take the form of a box for containing the set of problem cards 12. The packaging 14 might have printed on the outside thereof the purpose of the device 10, e.g., “PROBLEM CARDS FOR PREPARING FOR THE SAT” and “COMPATIBLE FOR USE WITH BRAND X GAME BOARD.”

A timer 18 might be included in the test preparation device 10 to simulate the time pressure encountered in a test. Timer 18 can take the form of any suitable timing device, e.g., a mechanical, electrical, or digital timer, a stopwatch, or an hour (minute) glass. Timer 18 could be arranged to time a given period (e.g., 1, 2, 3, 4, or 5 minutes). The end of the time period might be indicated by an audible or visual signal. Timer 18 is preferably be arranged to simulate the approximate time a student would have to answer an exam question (e.g., if a 2 hour exam contains 60 questions, the timer would be set to measure a 2 minute period).

As illustrated in FIGS. 1 and 3, the test preparation device 10 might also include a problem card holder 20 for holding the problem cards 13. Although the embodiment shown in FIG. 3 has six slots for holding card subsets 40, 42, 44, 46, 48, and 50, other variations of the problem card holder 20 may have a different number of slots. For example, the problem card holder 20 may be configured to have 2, 3, 4, 5, 7, 8, 9, 10, 11, 12 or more slots for holding the problem cards in separate piles according to the test area subset, e.g., with one problem card subset per slot. The different slots can be marked with a different discernible identifier (e.g., a shape) such that the problem cards can be separated and placed into a corresponding slot based on discernible identifier. In an alternative arrangement, a plurality of problem card holders might be used. For instance, the test preparation device might include several (e.g., 2, 3, 4, 5, 6, 7, 8, 9, or 10) separate problem card holders with each problem card holder being configured with a single slot to hold problem cards from a single test area subject subset in a separate pile. The different card holders might be marked with a different discernible identifier (e.g., color) such that the problem cards subsets can be separated and placed into a corresponding card holder based on discernible identifier.

A card holder might also be used to separate problem cards lacking a discernible marker based on subject subset. For example, problem cards are placed into one of several slots in one or more card holders based on subject subset. Although the problem cards are not marked with a discernible identifier, their placement into different marked slots based on subject subset allows them to be used with a game board having game token spaces marked with different discernible identifiers.

As shown in FIGS. 1 and 4, a game board 28 compatible with the problem cards 13 might also be included in the test preparation device 10. Although the game board 28 might take a number of different forms, the exemplary embodiment shown in FIG. 4 includes features a track 60 made up of twenty-four game piece spaces 62 (62a-62x) among which a player can move a token. Each of the spaces 62 is marked with a discernible identifier 52. In the particular embodiment shown in FIG. 4, the spaces are divided into six subsets with each different subset being marked with a different discernible identifier 52 (52a-52f) that correspond to six problem card subsets differing according to subject matter. In addition to different shapes, discernible identifiers 52 might take the form of a colored border around the inside perimeter of each space 62. In addition, discernible identifiers 52a, 52b, 52c, 52d, 52e, and 52f shown in FIG. 4, might be marked with different colors, e.g., red, blue, yellow, orange, green, purple, and pink.

To reduce the costs associated with including a game board in the test preparation device of the invention, it is preferred that a game board not be included with the device, and that the problem cards are designed to be compatible with game boards supplied with board games intended for recreation rather than studying or test preparation. For a game board that lacks discernible identifiers associated with game token spaces, the device of the invention can further provide discernible identifiers that may be reversibly or permanently associated with game token spaces on a game board. For example, such discernible identifiers may be on stickers or material having a means for permanently or reversibly attaching the material to a game board, e.g., an adhesive or a hook and loop type fastener.

Test preparation devices of the invention are preferably configured for the playing of a board game by two or more students/test takers (a student/test taker may be one person or a team of persons). The exact method of play will vary depending on the particular problem card set, other test preparation device components, and game board selected. In many instances, a game using the test preparation device and a game board from a game not intended for test preparation can be played according to the instructions accompanying the game not intended for test preparation or a slight modification thereof.

For devices compatible with game boards having thereon several different game piece spaces among which student/test taker can move game tokens, play is generally accomplished by one student/test taker rolling a die or dice and then moving his token the number of spaces indicated by the die or dice. The student/test taker is then asked a question from a problem card of the test area subject subset correlated with the landed on game token space (e.g., as indicated by the discernible identifier associated with the particular game space). If the student/test taker answers the question correctly, he is awarded a point or like reward, and then repeats his turn until he fails to answer a question correctly. Thereafter, the next student/test taker has his turn. The game continues until one student/test taker wins. Winning can be accomplished in a number of ways, e.g., by being the first student/test taker to answer a question from each test area subject subset correctly, by accumulating a target number of points, or by having the largest number of points after a designated time period (e.g., 30, 45, 60, 90, 120, or 180 minutes).

Rather than utilizing problem cards and a game board, the test preparation device of the invention might alternatively take the form of a computer program for use with an electronic device having controls and a display. When operating in a compatible electronic device, the program simulates game play as described in the foregoing problem card/game board embodiments. For example, the display might feature an image of a game board, and the controls might allow a student/test taker to electronically “roll” a die, to move a token among game token spaces on the game board image on the display, and to input answers to questions. After landing on a given game token space marked with a discernible identifier, the program causes a question in the test area subset associated with the discernible identifier to appear on the display. The student/test taker is provided an opportunity (e.g., a pre-determined period of time) to input an answer to the question. The computer program might be arranged to allow a single student/test taker to play alone or against 1, 2, 3, 4, 5, 6 or more fictional (generated by the program) or real players. The computer program might also incorporate other features such as a timing device and/or a scoring device.

The computer program can be arranged to be compatible with a variety of different electronic devices including hand held devices such as a cellular telephone, a personal digital assistant (PDA), or a gaming device such as the GAMEBOY brand gaming device marketed by Nintendo. It could also be arranged to be compatible with a conventional video game device (in combination with a video display) such as those marketed under the brand names: XBOX (Microsoft), PLAYSTATION 2 (Sony), and GAMECUBE (Nintendo).

In another embodiment, test preparation device of the invention might include a computer program running on a server accessible via a computer communications network such as the internet. In this embodiment, a student/test taker accesses the computer program via a personal computer communicating with the network, e.g., by directing his browser to a website at which the program can be accessed (e.g., run on the server's computer, or downloaded and run on the student/test taker personal computer). As in the electronic device embodiment, the program simulates game play as described in the foregoing problem card/game board embodiments. The computer program might be arranged to allow a single student/test taker to play alone or against 1, 2, 3, 4, 5, 6 or more fictional (generated by the program) or real players who might access the computer program from different locations.

### EXAMPLES

### Example 1

### Preparing For the SAT

In this example, two or more students prepare for the SAT using a TRIVIAL PURSUIT brand game board (see, e.g., U.S. Design Patent Number D270,741) and game accessories including a die, tokens, and scoring wedges. Rather than using the TRIVIAL PURSUIT brand trivia question and answer cards supplied with the board game, problem cards having questions similar to those that appear on the SAT are used. Examples of such questions are provided in commercially available SAT study material and practice examinations such as those marketed by the College Board, Kaplan Inc., and The Princeton Review.

Although the problem cards can be arranged similarly to TRIVIAL PURSUIT brand trivia question and answer cards (e.g., on one side, six questions each marked by different colors to indicate different categories; on the other side, the corresponding answers each marked by different colors to indicate different categories), to prevent confusion as to the source of the problem cards, those that differ in appearance from TRIVIAL PURSUIT brand trivia question and answer cards may be used. For example, SAT problem cards can contain only one question/answer each (this is also advantageous as SAT preparation questions can be much longer than typical trivia questions). To signify different categories, the cards may be marked with a color corresponding to a particular space on the game board (e.g., the entire card or parts of the card are blue, pink, yellow, brown, green, or orange). For instance, SAT problem cards may be arranged in six subsets (separated according to color marking) with each subset covering one or more SAT study subjects. As a particular example to illustrate this point, the blue card subset may contain only algebra questions, the pink card subset may contain only geometry and trigonometry questions, the yellow card subset may contain only improving sentence/paragraph questions, the brown card subset may contain identifying sentence error questions, the green card subset may contain only reading comprehension questions, and the orange card subset may contain only data analysis questions.

A problem card holder having six card holding slots can be used to conveniently hold each of the six problem card subsets in a one problem card subset per slot configuration. Each of the six slots can be marked with a different discernible identifier (e.g., color). Problem cards can be separated and placed into a corresponding slot based on discernible identifier. The card holder can also be used with problem cards lacking a discernible marker but separable based on subject subset. In this setup, the problem cards are placed into one of the six slots based on subject subset. While the problem cards are not necessarily marked with a discernible identifier, their placement into different marked slots based on subject subset allows them to be used with a game board having game token spaces marked with different discernible identifiers.

As one example, a problem card holder compatible with a TRIVIAL PURSUIT brand game board may have six slots including a first slot marked with blue, a second slot marked with pink, a third slot marked with yellow, a fourth slot marked with brown, a fifth slot marked with green, and a sixth slot marked with orange. For preparing for the SAT, for example, the blue slot might contain only algebra problem cards, the pink card slot might contain only geometry and trigonometry problem cards, the yellow card slot might contain only improving sentence/paragraph problem cards, the brown slot might contain only identifying sentence error problem cards, the green slot might contain only reading comprehension problem cards, and the orange slot might contain only data analysis problem cards.

Similar to the TRIVIAL PURSUIT brand trivia game, the SAT study method of this example is conducted by moving a token along the circular track and spokes of the game board in an effort to collect colored wedges awarded for correctly answering questions posed on the problem cards in each of the six subsets of the subject matter featured in the SAT. To “win,” a student returns to the hexagonal hub and correctly answers a question in an SAT study subset selected by the other player(s).

More specifically, as one variation of this example, at the start of the game, all playing students roll the die. The highest roller goes first by again rolling the die. This student moves his token, in the direction of his choice, the equivalent number of spaces indicated by the die (e.g., six spaces if the die reads 6). Another student then selects one card from the SAT subject problem card subset corresponding to the color of the space the high rolling student's token landed on (e.g., a blue algebra question/answer card if the student lands on a blue space; a green reading comprehension question/answer card if the student lands on a green). If the high rolling student answers the question correctly, he places the wedge of the corresponding color in his token, and then continues his turn by rolling the dice again. This is repeated until the high rolling player fails to answer a question correctly, whereupon the next student immediately to his left begins his turn. The game continues until one of the students “wins” by filling his token with all six different colored wedges, returning his token to the hexagonal hub, and correctly answering a question in an SAT study subset selected by one or more of the other players.

To simulate the time pressure encountered in the actual SAT, amount of time a student has to answer a question can be limited (e.g., to 1, 2, or 3 minutes). A timing device such as a timer, stopwatch or hourglass may be used to facilitate this.

### Example 2

### Problem Cards For Preparing For Law Licensure Exams

In this example, the problem cards contain a single question on one face of the problem card and the corresponding answer on the other face of the card. Questions are divided according to subject matter into one of the following six subsets: torts, property, contracts, civil procedure, criminal law, and constitutional law and criminal procedure. Torts problem cards are marked with a blue border. Property problem cards are marked with a pink border. Contracts problem cards are marked with a yellow border. Civil procedure problem cards are marked with a brown border. Criminal law problem cards are marked with a green border. Constitutional law and criminal procedure problem cards are marked with an orange border.

### Example 3

### Problem Cards For Preparing For An Organic Chemistry Examination

In this example, the problem cards contain a question on one face of the problem card and an answer on the other face of the card. Questions are divided according to subject matter into one of the following subsets: acids and bases; addition, elimination, and substitution reactions; bonding; structures; methods of chemical analysis; nomenclature; stereochemistry; and oxidation/reduction reactions. Problem cards feature one problem/answer per card. Problem cards are shaped or marked with a shape (e.g., a regular polygon) according to the subject subset of the cards. For example, acids and bases problem cards are marked with or shaped like a triangle; addition, elimination, and substitution reactions problem cards are marked with or shaped like a square; bonding problem cards are marked with or shaped like a regular pentagon; structures problem cards are marked with or shaped like a regular hexagon; methods of chemical analysis problem cards are marked with or shaped like a regular octagon; nomenclature problem cards are marked with or shaped like a circle; stereochemistry problem cards are marked with or shaped like an oval; and oxidation/reduction reactions are shaped like a rectangle.

A game board for use with the problem cards contains a plurality of game token spaces including at least one for each of the foregoing shapes/question subsets. Each student/player advances a token around the game board according to his roll of a die. Problem cards are selected based on the shape corresponding to the space a student's token lands on. Student/players are awarded one point for each correct answer. The first student/player to win a predetermined number (e.g., twenty) points wins the game.

### Example 4

### Problem Cards For Preparing For A Biology Examination

A set of problem cards for preparing for a test in the biology test area includes a subset of cards having questions in genetics. This subset of cards has thereon a double helix icon as a discernible identifier, and an identifier indicating the relative difficulty of the problem (e.g., easy, medium, hard, or very hard), and/or an identifier that indicates the question is within certain subcategories of the genetics subset, e.g., inheritance of traits (identifier is a small pedigree symbol), karyotyping (identifier is an image of a chromosome), and human genetic diseases (identifier is a caduceus). Each problem cards also includes an answer to the question, an explanation of the answer and/or a suggested approach or strategy for addressing the question.

### Other Embodiments

It is to be understood that while the invention has been described in conjunction with the detailed description thereof, the foregoing description is intended to illustrate and not limit the scope of the invention, which is defined by the scope of the appended claims. For example, although the invention has been described using problem cards, other media (a plastic chip) containing questions/answers might be used. In addition, the invention is not limited to games featuring game boards as other games that use questions/answers are known that do not require the use of a game board. Other aspects, advantages, and modifications are within the scope of the following claims.

What is claimed is:

1. A method for preparing at least a first person and at least a second person for a: standardized test selected from the group consisting of the SAT, the ACT, an SAT subject test, the PSAT/NMSQT; an AP test, a CLEP test; the GRE general test, a GRE subject test, the MCAT, the LSAT, the DAT, the PCAT, the OAT, the VCAT, the AHPAT, the GMAT, the MAT, a state bar exam, the MBE, the MPRE, the patent bar examination, a medical board exam, a veterinary board exam, a dental board exam, an optometric board exam, a chiropractic board exam, an osteopathic board exam, a pharmacy board exam, a CPA test, series 6 and 7 exams, the TOEFL, the TSWE; a high school equivalency exam; and the FCAT, the method comprising the steps of:
providing a test preparation device compatible for use with a game board comprising at least a first game token space and a second game token space, the device comprising a plurality of problem cards each having thereon at least one question in a test area consisting of subject matter from a standardized test, the plurality of problem cards comprising at least (a) a first card comprising (i) a first discernible identifier corresponding to the first game token space and a first subset of the test area, (ii) a first test preparation question relating to the first subset of the test area, (iii) a correct answer to the first test preparation question; and (b) a second card comprising (i) a second discernible identifier corresponding to the second game token space and a second subset of the test area and (ii) a second test preparation question relating to the second subset of the test area, and (iii) a correct answer to the second test preparation question; wherein the first discernible identifier differs from the second discernible identifier, the first test preparation question differs from the second test preparation question, and the first subset differs from the second subset;
providing the game board;
having the first person read the first test preparation question on the first card to the second person;
allowing the second person to provide an answer to the first test preparation question;
having the first person determine whether the second person's answer is the same as the correct answer to the first test preparation question;
having the second person read the second test preparation question on the second card to the first person;
allowing the first person to provide an answer the second test preparation question; and
having the second person determine whether the first person's answer is the same as the correct answer to the second test preparation question.

2. The method of claim 1, wherein first card comprises a question difficulty identifier, and the first person reads the question difficulty identifier to the second person.

3. The method of claim 1, wherein first card comprises an explanation/approach for addressing the first test preparation question.

4. The method of claim 3, wherein the first person reads the explanation/approach to the second person.

5. The method of claim 3, wherein the explanation/approach for addressing the first test preparation question comprises an explanation of how the first test preparation question is typically solved.

6. The method of claim 3, wherein the explanation/approach for addressing the first test preparation question comprises a suggested shortcut approach for correctly answering the first test preparation question.

7. The method of claim 1, further comprising the step of:
limiting the amount of time the second person has to answer the first test preparation question to simulate the time pressure associated with the standardized test.

8. The method of claim 7, wherein the amount of time is selected from the group consisting of 1, 2, 3, 4, and 5 minutes.

9. The method of claim 1, wherein the game board is one originally intended for recreation rather than preparing for a standardized test.

10. The method of claim 1, wherein the first person arranges the plurality of problem cards into different slots of a problem card holder according to each card's test area subset.

11. The method of claim 10, wherein the problem card holder comprises at least a first slot marked with the first discernible identifier and a second slot marked with the second discernible identifier.

12. The method of claim 1, wherein the game board lacks discernible identifiers associated with game token spaces, and the method further comprises associating the discernible identifiers with the game token spaces.

13. The method of claim 12, wherein the discernible identifiers are permanently associated with the game token spaces.

14. The method of claim 12, wherein the discernible identifiers are reversibly associated with the game token spaces.

15. The method of claim 12, wherein the discernible identifiers are associated with the game token spaces using an adhesive.
